(19) United States
(12) Patent Application Publication
(10) Pub. No.: US 2013/0022854 A1
(43) Pub. Date: Jan. 24, 2013

(54) HEATING MODULE FOR MAINTAINING BATTERY WORKING TEMPERATURE

(71) Applicant: Tzu-Chin Chiu, New Taipei City (TW)

(72) Inventor: Tzu-Chin Chiu, New Taipei City (TW)

(21) Appl. No.: 13/187,740

(22) Filed: Jul. 21, 2011

(51) Int. Cl. H01M 10/50

(52) U.S. Cl. 429/120

(57) ABSTRACT

A heating module for maintaining battery working temperature is arranged adjacent to one side of a battery module, and includes a heating element and a heat dissipation unit. The heat dissipation unit includes a base and a plurality of radiating fins provided on one face of the base; the base has another opposite face in contact with one side of the heating element; and the battery module is adjacent to one side of the heat dissipation unit opposite to the heating element, such that a convection space is defined between the battery module and the heat dissipation unit. With the heating module, a battery module can stably maintain at its working temperature to work in upgraded working efficiency and can have prolonged service life.

### FIELD OF THE INVENTION

The present invention relates to a heating module, and more particularly to a heating module for maintaining a battery module at its working temperature, so that the battery module can have upgraded working efficiency and prolonged service life.

### BACKGROUND OF THE INVENTION

In the occasion where household AC power or general DC power is not available, a battery is usually used to supply electric power. For instance, various kinds of vehicles, lamps, power tools, electronic devices, communication devices and heat exchangers all can use one or more batteries to obtain required power supply. However, a battery used in a working environment having a low temperature from about −20° C. to about −30° C. would not be able to supply power at all. Therefore, in extremely cold areas or countries and in working places that require very low temperature, special measures have been taken for batteries to reach their working temperature and to supply electric power in a normal manner.

For the batteries to keep working normally in the low ambient temperature, it is also necessary to maintain the batteries at their required working temperature.

It is therefore tried by the inventor to overcome the above-mentioned problems by developing a heat module for maintaining battery working temperature.

### SUMMARY OF THE INVENTION

A primary object of the present invention is to provide a heating module that is used to raise the ambient temperature surrounding a battery module, so that the battery module can reach its working temperature to supply power in a normal manner.

Another object of the present invention is to provide a heating module for maintaining a battery module at its working temperature, so that the battery module can have upgraded working efficiency and prolonged service life.

To achieve the above and other objects, the heating module according to the present invention is arranged adjacent to one side of a battery module, and includes a heating element and a heat dissipation unit. The heating element has a first side and an opposite second side. The heat dissipation unit includes a base and a plurality of radiating fins; the radiating fins are axially extended along and parallelly spaced from one another on one face of the base; and the base has another opposite face in contact with the first side of the heating element. The battery module is adjacent to one side of the heat dissipation unit opposite to the heating element, such that a convection space is defined between the battery module and the heat dissipation unit. By connecting the heating element and the heat dissipation unit with each other to form the heating module of the present invention, the heat module can effectively maintain a battery module located adjacent thereto at its working temperature, allowing the battery module to have upgraded working efficiency and prolonged service life.

### BRIEF DESCRIPTION OF THE DRAWINGS

The structure and the technical means adopted by the present invention to achieve the above and other objects can be best understood by referring to the following detailed description of the preferred embodiments and the accompanying drawings, wherein

FIG. 1 is an exploded perspective view of a heating module for maintaining battery working temperature according to a first preferred embodiment of the present invention;

FIG. 2 is an assembled view of FIG. 1;

FIG. 3 is a side view of the heating module of FIG. 1 in use;

FIG. 4 is a perspective view of the heating module of FIG. 1 in use;

FIG. 5 is an exploded perspective view of a heating module for maintaining battery working temperature according to a second preferred embodiment of the present invention;

FIG. 6 is an assembled view of FIG. 5;

FIG. 7 is a side view of the heating module of FIG. 5 in use; and

FIG. 8 is a perspective view of the heating module of FIG. 5 in use.

### DETAILED DESCRIPTION OF THE PREFERRED EMBODIMENTS

The present invention will now be described with some preferred embodiments thereof and with reference to the accompanying drawings. For the purpose of easy to understand, elements that are the same in the preferred embodiments are denoted by the same reference numerals.

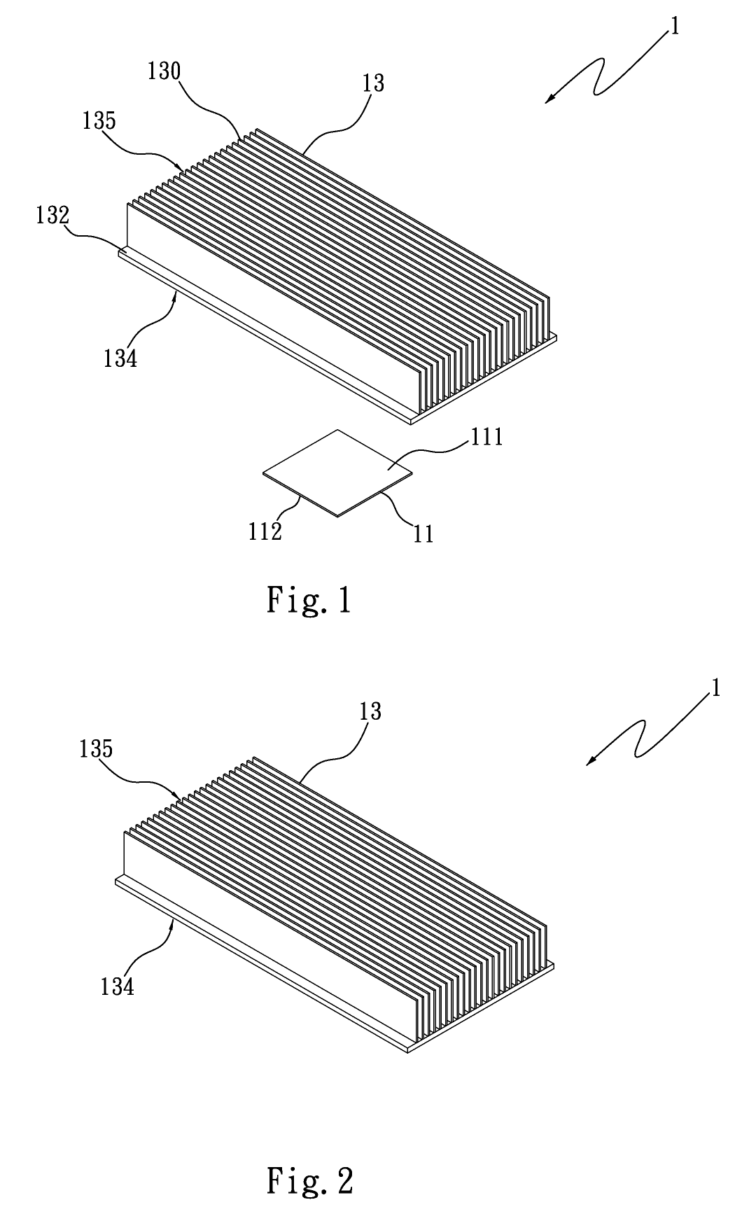

Please refer to FIGS. 1 and 2 that are exploded and assembled perspective views, respectively, of a heating module for maintaining battery working temperature according to a first preferred embodiment of the present invention. For the purpose of conciseness, the present invention is also briefly referred to as a heating module herein and is generally denoted by reference numeral 1. As shown, the heating module 1 in the first embodiment includes a heating element 11 and a heat dissipation unit 13. The heating element 11 can be a thermistor, a quartz heater, a positive temperature coefficient (PTC) heater, or an IC (integrated circuit) heater. And, the heating element 11 has a first side 111 and an opposite second side 112.

The heat dissipation unit 13 includes a plurality of radiating fins 130 and a base 132. The radiating fins 130 are axially extended and parallelly spaced from one another on one face of the base 132. Another opposite face of the base 132 is in contact with the first side 111 of the heating element 11. That is, the heating element 11 is located on one side of the base 132 opposite to the radiating fins 130.

The base 132 includes a heat absorption section 134 formed on the face of the base 132 facing toward the first side 111 of the heating element 11 for absorbing heat generated at the first side 111 of the heating element 11. In the illustrated first embodiment, the heat dissipation unit 13 is a heat sink, such as an aluminum-extruded heat sink without being limited thereto. For example, the heat dissipation unit 13 can be otherwise a radiating fin assembly.

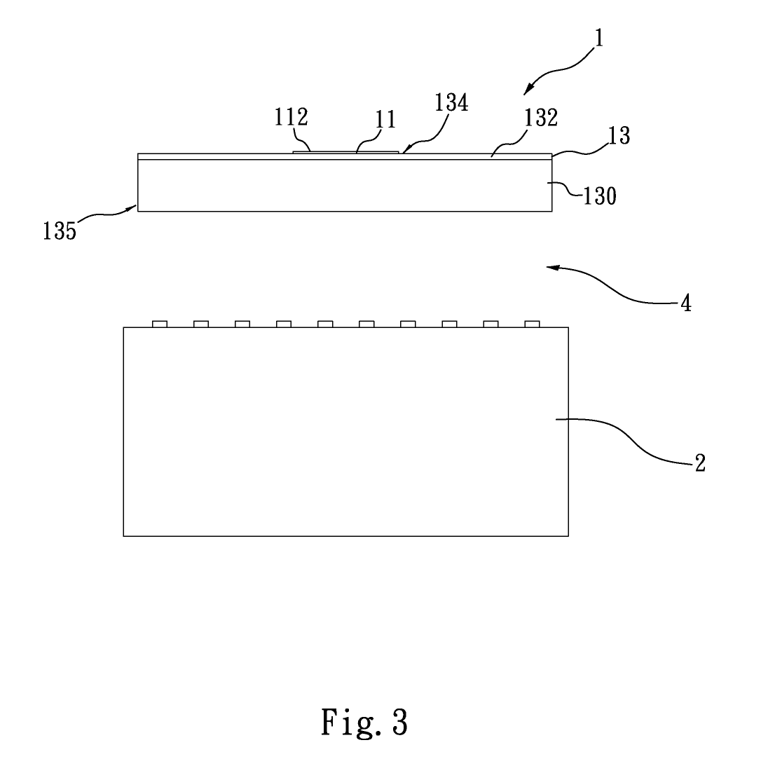

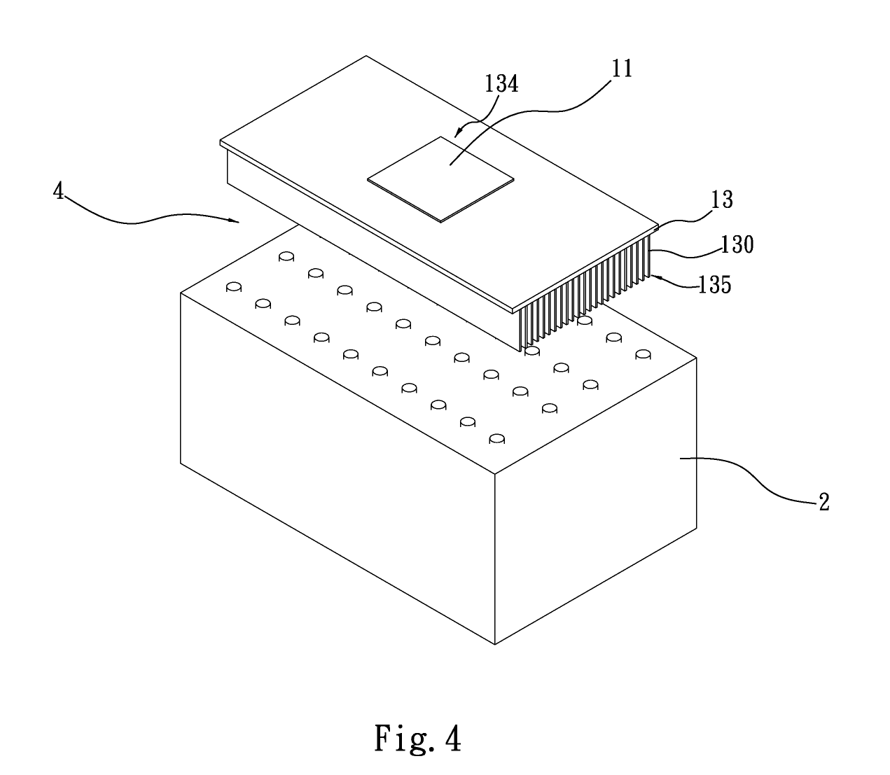

FIGS. 3 and 4 are side and perspective views, respectively, showing the heating module 1 is arranged adjacent to a battery module 2 for use. As shown, the heating radiating fins 130 together define a heat dissipation section 135 for radiating the heat transferred to and absorbed by the heat absorption section 134 into a convection space 4 defined between the heat dissipation unit 13 and the battery module 2, so as to heat the battery module 2 and maintain the same at its working temperature for supplying power in a normal manner.

When the battery module 2 is lower than its working temperature required for supplying power, the heating element 11 is actuated to generate heat, and the heat absorption section 134 absorbs the generated heat from the first side 111 of the heating element 11 and transfers the absorbed heat to the heat dissipation section 135, that is, the radiating fins 130, from where the received heat is radiated into the convection space 4 to thereby raise the ambient temperature surrounding the battery module 2, bringing the battery module 2 to reach its working temperature. In this manner, the battery module 2 can have upgraded power supply efficiency and effectively prolonged service life.

Further, since the heating module 1 and the battery module 2 all are modularized, they can be more easily separated from each other for convenient maintenance or repair.

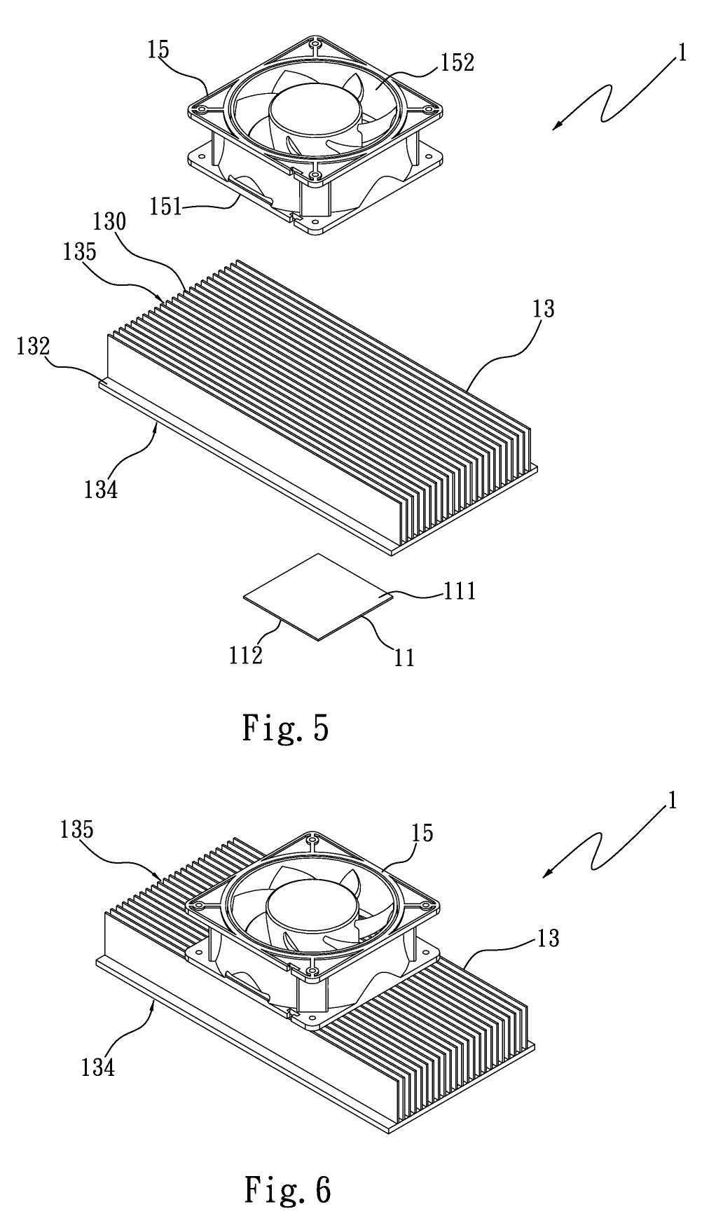

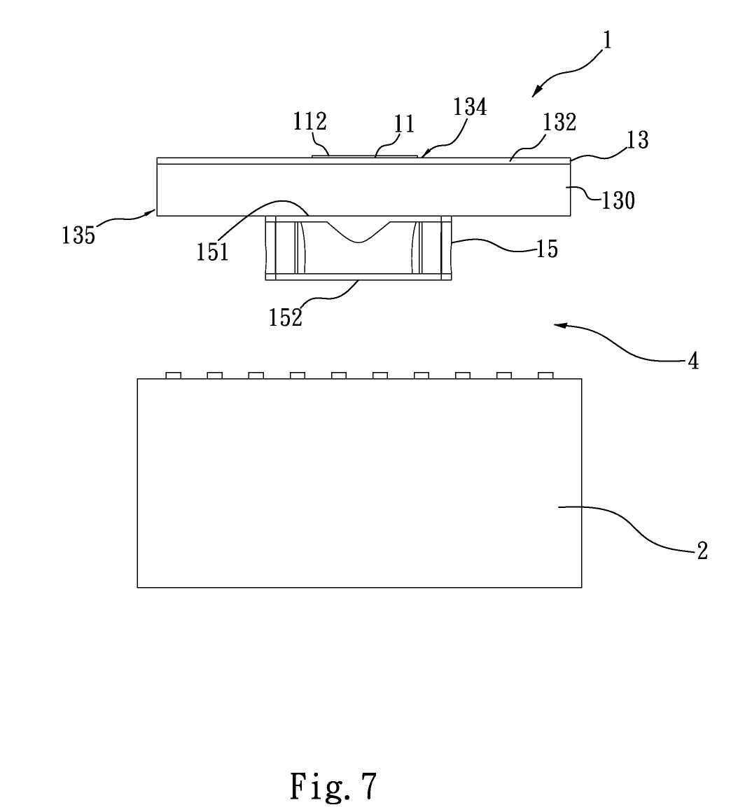

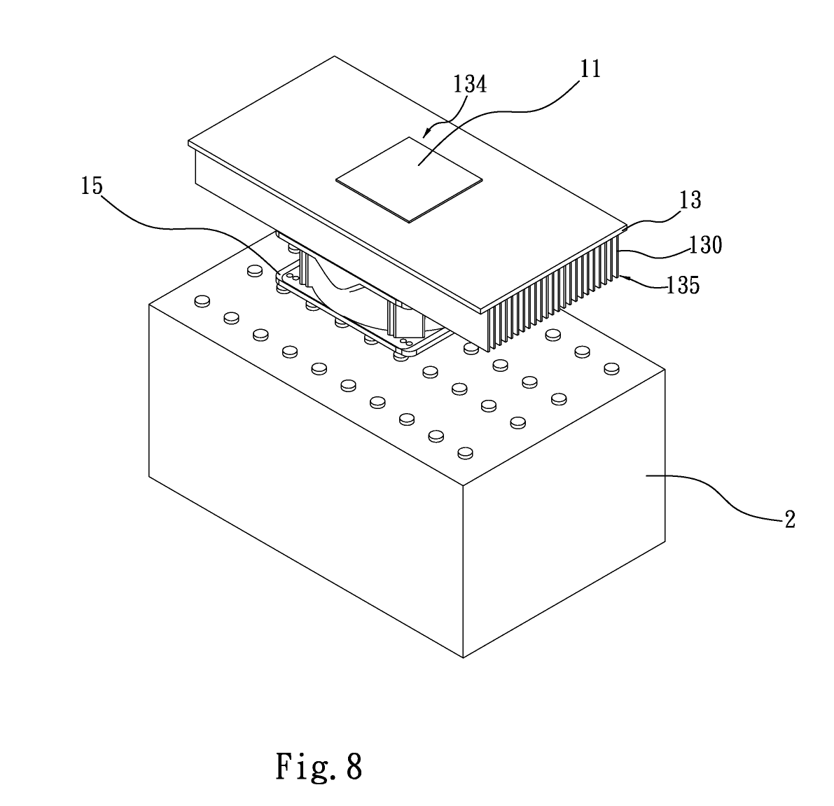

FIGS. 5 and 6 are exploded and assembled perspective views, respectively, of a heating module for maintaining battery working temperature according to a second preferred embodiment of the present invention. As shown, the second embodiment is generally structurally similar to the first embodiment, except for a fan 15 that is further arranged to one side of the heat dissipation unit 13 opposite to the heating element 11. The fan 15 has an air-in side 151 adjoining the radiating fins 130 and an opposite air-out side 152 facing toward the battery module 2, as can be seen in FIGS. 7 and 8, which are side and perspective views, respectively, showing the heating module 1 is arranged adjacent to a battery module 2 for use. When the fan 15 operates, hot air carrying the heat from the radiating fins 130 (i.e. the heat dissipation section 135) is guided into the fan 15 via the air-in side 151 and then forced toward the battery module 2 via the air-out side 152 to quickly raise the ambient temperature surrounding the battery module 2.

Please refer to FIGS. 7 and 8. When the battery module 2 is lower than its working temperature required for supplying power, the heating element 11 is actuated to generate heat, and the heat absorption section 134 absorbs the generated heat from the first side 111 of the heating element 11 and transfers the absorbed heat to the heat dissipation section 135, that is, the radiating fins 130, from where the received heat is radiated into the convection space 4 to thereby raise the ambient temperature surrounding the battery module 2. Meanwhile, a large part of the heat is sucked into the operating fan 15 via the air-in side 151 to form hot air flows, which are then guided toward the battery module 2 via the air-out side 152 of the fan 15 to enforce quick heating of the battery module 2. With these arrangements, the battery module 2 can quickly reach its working temperature. In this manner, the battery module 2 can have upgraded power supply efficiency and effectively prolonged service life.

In conclusion, the heating module according to the present invention has the following advantages: (1) enabling the battery module to have prolonged service life; (2) enabling the battery module to have upgraded working efficiency; and (3) allowing the heating module and the battery module to be quickly modularized.

The present invention has been described with some preferred embodiments thereof and it is understood that many changes and modifications in the described embodiments can be carried out without departing from the scope and the spirit of the invention that is intended to be limited only by the appended claims.

What is claimed is:

1. A heating module for maintaining battery working temperature and being arranged adjacent to one side of a battery module, comprising:
a heating element having a first side and an opposite second side; and
a heat dissipation unit including a base and a plurality of radiating fins; the radiating fins being axially extended and parallelly spaced from one another on one face of the base; and the base having another opposite face in contact with the first side of the heating element; and
wherein the battery module is adjacent to one side of the heat dissipation unit opposite to the heating element, such that a convection space is defined between the battery module and the heat dissipation unit.

2. The heating module for maintaining battery working temperature as claimed in claim 1, wherein the base of the heat dissipation unit includes a heat absorption section formed on the face of the base facing toward the first side of the heating element; the heat absorption section being in contact with the first side of the heating element; and wherein the radiating fins together define a heat dissipation section.

3. The heating module for maintaining battery working temperature as claimed in claim 2, further comprising a fan being arranged on the side of the heat dissipation unit facing toward the battery module; the fan having an air-in side adjoining the radiating fins and an opposite air-out side facing toward the battery module.

4. The heating module for maintaining battery working temperature as claimed in claim 1, wherein the heat dissipation unit is selected from the group consisting of a heat sink and a radiating fin assembly.

5. The heating module for maintaining battery working temperature as claimed in claim 1, wherein the heating element is selected from the group consisting of a thermistor, a quartz heater, a positive temperature coefficient (PTC) heater, and an IC (integrated circuit) heater.
